(19) United States
(12) Patent Application Publication
(10) Pub. No.: US 2008/0137544 A1
(43) Pub. Date: Jun. 12, 2008

(54) Method and terminal for setting up a packet-oriented communication link

(75) Inventor: Bertram Geck, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/983,863

(22) Filed: Nov. 13, 2007

(30) Foreign Application Priority Data
Nov. 14, 2006 (EP) 06023662.7

(51) Int. Cl. G06F 11/00

(52) U.S. Cl. 370/248

(57) ABSTRACT

A packet-oriented communication link is set up from a first to a second terminal in a data network. The first terminal sends a test data packet to the second terminal, the route of the test data packet in the data network being detected. The detected route is used to check whether the first and the second terminal are arranged in the same local address space. The local address of the first terminal is used as sender address for setting up the communication link in cases in which the result of the check is positive, and the global address is used in the other cases.

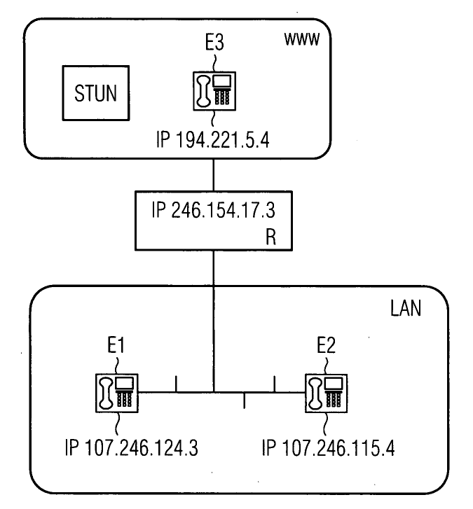

### CROSS REFERENCE TO RELATED APPLICATIONS

This application claims priority of European Patent Office application No. 06023662.7 EP filed Nov. 14, 2006, which is incorporated by reference herein in its entirety.

### FIELD OF INVENTION

The invention relates to a method for setting up a packet-oriented communication link and to a terminal for setting up a packet-oriented communication link in a data network.

### BACKGROUND OF INVENTION

Data networks are used not only for transmitting electronic messages (e.g. e-mails), transmitting internet pages and other “offline” content, but also for real-time communication links. The latter communication links usually comprise data streams (media streams) which comprise a series of data packets which are usually transmitted using the internet protocol between terminals, servers or other network elements. One known example of such data-stream-oriented communication links are internet telephone calls, known as VoIP (Voice Over Internet Protocol) links. In this case, the useful contents (for example digitized audio signals, moving images etc.) are added to data packets (IP datagrams), are provided with a communication address (IP address) for the receiver appliance and are then transmitted by means of a local area data network (LAN=Local Area Network) or using a public data network (usually the internet).

The setup and execution of such a packet-oriented communication link usually involve the use of customary communication protocols such as ITU-T-H.323 or SIP (Session Initiation Protocol). This involves signaling messages being exchanged according to protocol between a terminal which sets up a communication link and the called remote station (either another terminal or a network component, such as a gateway, gate keeper, server etc.), said signaling messages preparing for the subsequent exchange on the actual useful data link (useful data streams). In the domain of the SIP protocol, for example, such a signaling message is referred to as an “invite” message. Such a message comprises not only the communication address (in this case: IP address) at the called terminal but also a “sender address”, that is to say the IP address of the calling terminal. The “sender address” is used both for sending the signaling messages in the opposite direction, that is to say from the called terminal to the calling terminal, and for sending all useful data packets which are supposed to be transmitted from the called terminal to the calling terminal.

In cases in which both the called terminal and the calling terminal are either both arranged in the same local area data network or both arranged in the same global data network (for example the internet), both terminals belong to the same address space. In these cases, both the called terminal and the calling terminal can respectively use that IP address which is respectively permanently associated with this terminal for the purpose of setting up the communication link. Terminals which are arranged in local area data networks (e.g. company intranets, home networks etc) are usually not equipped with a globally valid internet address (IP address). One reason for this is that the address space for the currently customary version of the internet protocol (IPv4) comprises only four bytes, which results in the address space (address supply) formed thereby not being sufficient to equip all computers and network elements worldwide with a dedicated, explicit IP address. For this reason, appliances in private communication networks or data networks are addressed using IP addresses which are only locally explicit. Such private networks are connected to the public, global internet using special network elements (routers, gateways). These network elements (gateways, routers) in turn are equipped with one or more globally valid and explicit IP addresses which can be used to address them from the internet. Data packets which are transmitted from a local data network with local addresses to an appliance on the internet via such a network element have their sender address converted in this network element. Such a method is the known NAT (Network Address Translation) method, which replaces the locally valid sender address in the relevant data packets with a globally valid internet address and sends the data packets arriving in the opposite direction from the internet using the local IP address of the relevant computer or terminal and therefore forwards them to the correct local terminal point.

The NAT method described works simply and reliably for data packets in which the sender address is entered only in the “header” of the IP data packets and hence also needs to be exchanged by the NAT entity only in the header. However, many communication protocols, such as the aforementioned SIP protocol, involve the sender addresses also being encoded in the “higher protocol layers”, which means that the useful content of the data packets, that is to say outside of the header, also contains address statements which likewise need to be edited by the NAT process. However, this means that the respectively used NAT entity needs to “know” the structure of the useful content of the data packets in a wide variety of communication protocols, which results in the NAT entity needing to be of very complex design. Such a method is therefore complex and hence also maintenance-intensive and not always reliable in operation.

One solution to this problem is to use what are known as STUN (Simple Traversal of UDP Messages over NAT) servers. STUN servers are usually arranged outside of the local area data networks, that is to say are connected directly to the internet, for example, and are frequently provided by internet providers. A calling terminal which is in a local area data network, for example, can use a request message to the STUN server in order to find out the global internet address (IP address) associated with this terminal. When a NAT entity is used, the address ascertained in this manner is often that IP address which the NAT entity would insert into the data packet of the request message instead of the local IP address of the calling terminal. The IP address found out in this manner can then be used as “sender address” by the calling terminal in the aforementioned “higher protocol layers” of the communication protocol used, so that it is possible to communicate with a called terminal without difficulty even when this called terminal is arranged outside of the intrinsic local area network.

### SUMMARY OF INVENTION

One problem with the outlined method is that although large private data networks, in particular, have a uniform “private” address space they may comprise a multiplicity of domains and sub networks, so that a calling terminal, upon making contact with a called terminal, cannot use the IP address of the called terminal to distinguish whether or not this called terminal is part of the intrinsic private data network, that is to say the intrinsic address space. For this reason, the outlined method, which includes making contact with the STUN server, is frequently carried out for all communication links even though it is actually not needed in many cases. This means that many communication links are unnecessarily routed via the internet even though they actually involve a communication link which could be handled completely in the intrinsic, private network. Besides unnecessarily taking up resources, this also means an increased security risk, because it must be assumed that the data packets routed via the internet can be “monitored” or manipulated more easily than data packets transported “internally” in a private data network.

It is thus an object of the present invention to optimize communication links from local terminals to other terminals.

The way in which this object is achieved is specified in the independent patent claims.

In this regard the object is achieved by providing a method for setting up a packet-oriented communication link from a first to a second terminal in a data network, where the data network comprises a local area data network with local addresses in a local address space and a public data network, connected thereto, with global addresses, where the first terminal is arranged in the local area data network, and where the first terminal has an associated local address for communication links within the local area data network and an associated global address for communication links to terminals in the public data network. In this case, in a first step the first terminal sends a test data packet to the second terminal, the route of the test data packet in the data network being detected, in a second step the detected route is used to check whether the first and the second terminal are arranged in the same local address space, and in a third step the local address of the first terminal is used as sender address for setting up the communication link in cases in which the result of the check is positive, and the global address is used in the other cases. This means that communication links between terminals in a local address space are not routed unnecessarily via a public network, which saves resources, lowers costs and increases data integrity. Network elements such as routers and NAT entities do not need to be reprogrammed, which means that the method can be used in customary infrastructures.

The object is also achieved by providing a terminal for setting up a packet-oriented communication link in a data network, having a device for sending a test data packet to a second terminal, having a means for detecting the route taken by the test data packet in the data network, having a means for evaluating the detected route, these means being able to establish whether the second terminal is arranged in the same address space as the first terminal, having a means for detecting a global address associated with the first terminal, and a device for setting up the communication link to the second terminal, this device being in a form such that in cases in which the second terminal is arranged in the same address space as the first terminal a local address for the first terminal is used as sender address, and a detected global address of the first terminal is used in other cases. The use of such a terminal avoids the drawbacks when using STUN servers and other methods which provide for the fundamental use of global addresses for communication links, by virtue of a case-by-case decision being able to be provided for the use of global or local addresses. In this case, the terminal and hence also the method can also be used in networks in which the terminals involved are not arranged in the same sub network or the same domain.

Advantageous refinements of the method are specified in the dependent patent claims. The features and advantages described for the method can also be applied in corresponding fashion to the inventive terminal, and vice versa.

Connections to terminals outside of the local address space of the first terminal can be set up easily and using customary network engineering e.g. simple NAT entities, if in or before the third step the global address associated with the first terminal is ascertained by accessing a STUN-server at least in cases in which the result of the check is negative.

In many cases, it is sufficient if the check involves the number of hops when transmitting the test data packet to the second terminal being detected and evaluated. The check then advantageously involves the number of hops by a further test data packet to the STUN server being ascertained and compared with the number of hops by the test data packet to the second terminal. If the number of hops is identical, it can be concluded that the called terminal and the STUN server are in the same address space, that is to say the public network. In these cases, it is often possible to dispense with further analyses of the former test data packet.

Optimized routing can be performed if the check establishes whether the second terminal and the STUN server are in a data network with the same address space, and if so the global address is used in the third step. A frequent instance of application is covered in this case when the public data network used is the internet.

### BRIEF DESCRIPTION OF THE DRAWINGS

Exemplary embodiments of the inventive method are explained below with reference to the drawing. They are simultaneously used to explain exemplary embodiments of inventive terminals.

In this context, the single FIGURE shows a schematic illustration of terminals in a local area data network and in a public data network.

### DETAILED DESCRIPTION OF INVENTION

The FIGURE shows terminals E1, E2, E3 in the local area data network LAN and in the public data network WWW. In these exemplary embodiments, the local area data network LAN is a highly ramified data network in a company. The public data network WWW in this exemplary embodiment is the internet; it goes without saying that other data networks LAN, WWW may also be used. The local area data network LAN is linked to the public data network WWW via a router R.

The terminals E1, E2, E3 have the respective associated communication addresses (in this case: IP addresses) shown for them. The IP address shown for the router is that internet address which is associated with the internet's interface (not shown) for the router R; the router R can therefore be addressed from the public data network WWW using the IP address 246.154.17.3. The router R can likewise be addressed from the local area data network LAN; the associated IP address is not shown. The router R is equipped with a NAT entity (NAT server) which is used for address conversion (Network Address Translation) or for port conversion (PAT=Port Address Translation). Data packets which are routed to the public data network WWW by the terminals E1, E2 are provided with the “sender address” 246.154.17.3, that is to say the IP address of the NAT entity and of the router R, in their IP header by the router R or the NAT entity.

The local area data network LAN, which, for reasons of clarity, is shown here only with the network elements which are relevant to this description, namely the terminals E1, E2 and the router R, is divided into various domains and data sub networks, so that although the terminals E1 and E2 belong to the same address space the terminals E1 and E2 do not contain any information about which of the terminals E1, E2, E3 are arranged in the local area data network LAN and which belong to a different data network, for example the public data network WWW.

Besides the terminal E3, the public data network also contains an addressing server STUN (Simple Traversal of UDP messages over NAT), also called STUN server.

The STUN server has, inter alia, a function which permits communication links, usually internet telephone calls based on the SIP standard, between terminals E1, E2 in a local area data network and terminals E3 in a public data network. In this context, the STUN server acts as a “switching station” for the useful data streams, with the STUN server respectively receiving the data packets in the useful data streams from a sending terminal and forwarding them to the receiving terminal. This function is not meant to be used for the communication links in this exemplary embodiment, however, because for reasons of data integrity and resource optimization, and not least also in order to minimize the delay times for the data packets, the useful data streams and also the signaling messages are meant to be exchanged directly between the terminals E1, E2 and E3. The method described in RFC3489 (RFC=Request For Comment) is thus not meant to be used.

Another function of STUN servers which is used here involves terminals E1, E2, E3 being able to use a request message to the STUN server to ascertain the globally valid IP address at which this respective terminal E1, E2, E3 can be reached. In the present exemplary embodiment, the addressing server STUN (STUN server) would respond to a corresponding request message from a terminal E1 with a response message which comprises the IP address 246.154.17.3 together with an associated IP port number. This is because this is the address which the router R or the NRT entity installed in the router R associates as “sender address” with those data packets which are transmitted from the local area data network LAN to components and entities in the global data network WWW. The addressing server STUN would respond to an identical request message from the terminal E3 with the IP address 194.221.5.4 because data packets from the terminal E3 are not “readdressed” by a NAT entity which means that the IP address 194.221.5.4 associated with the network interface of the terminal E3 represents a valid internet address per se.

The text below refers to the FIGURE to explain a first case example in which a real-time communication link is intended to be set up from the terminal E1 to the terminal E2. In this context, it is assumed that the terminal E1 contains information about the communication address of the terminal E2, that is to say in this case the IP address 107.246.115.4. When the IP address of the desired communication partner is not available, such an address can be found out by accessing an SIP proxy server, a directory server, a DNS server or the like; such practice corresponds to the prior art. Since the terminal E1 does not contain any information about whether the terminal E2 or the IP address of the terminal E2 belongs to the same address space, that is to say the same local area data network LAN as the terminal E1, the terminal E1 now sends a test message or a test data packet to the IP address of the terminal E2. The progress of this test data packet or of the test message is recorded in this case; this is also referred to as “tracing”. In this context, appropriate network diagnosis means based on the prior art register the network elements, particularly routers, encountered and also ascertain the number of necessary “hops” by the test message on its way from the terminal E1 to the terminal E2.

The analysis of the test data packet sent or of its “path” shows that no “hop” was made, that is to say that no router was used. This shows the terminal E1 that the terminal E2 is arranged in the same (local) address space, as a result of which the “intrinsic” IP address of the terminal E1, namely 107.246.124.3, can be used not only in the header of the data packets sent to the terminal E2 (in this case specifically the SIP Invite message) but also in the “higher protocol layers” of the communication (in this case: SIP communication). In this context, cases may also arise in which the number of “hops” is not equal to zero even though both terminals E1, E2 in question are in the same private, local area data network LAN. In such cases, an analysis of the network nodes which the test data packet has encountered shows whether the address of the called terminal E2 belongs to the same private data network LAN. Such analysis can also ascertain whether the test data packet has been routed from the local area data network LAN into a global data network WWW and from there back into the same local area data network LAN. In such cases too, “direct communication” with exclusive use of the locally valid IP addresses is possible and advantageous.

The text below considers the case in which the terminal E1 sets up a communication link to the “external” terminal E3. As a departure from the case shown figuratively, the terminal may also be arranged in a third, local area data network “downstream” of a further NAT entity. In this case too, a test data packet is now sent from the terminal E1 to the terminal E3, with an analysis of the progress of the test data packet showing that the data packet encountered only one “hop”, namely the router R. The terminal E1 now sends a further data packet, namely a request message for ascertaining the intrinsic “external” IP address, to the addressing server STUN. The progress of this second test message is also analyzed, with the result ascertained likewise being a “hop” via the router R. This shows the terminal E1 that the addressing server STUN and the terminal E3 are in the same data network WWW.

Just like the analyses described above, this analysis can be performed either by the terminal E1 itself or by an external entity. In particular, it is possible to use an appropriately equipped SNMP (Simple Network Management Protocol) server. Such a service is not only able to analyze the progress of data packets (test messages) but rather often also has detailed information about the topology of the “intrinsic” network, its domain structure and the “intrinsic” address space, so that an analysis of the network element (e.g. routers) encountered by the test data packet can provide a direct inference about whether or not the destination reached by the test data packet, namely the terminal E2, is an “external” terminal.

On the basis of the request message, the addressing server STUN sends the terminal E1 a response message which comprises the “external visible” IP address and IP port number of the terminal E1; in this case, the IP address is identical to the “external” IP address of the router R namely 246.154.17.3. In light of the fact that the called terminal E3 is outside of the intrinsic address space, the terminal E1 now uses its “external visible” IP address 246.154.17.3 in the higher protocol layers of the SIP protocol, particularly as “sender address”, which is to be used by the terminal E3 for response messages and for the useful data stream that is to be sent from the terminal E3 to the terminal E1. However, the IP headers of the data packets which are sent from the terminal E1 to the terminal E3 initially carry the locally valid IP address of the terminal E1, namely 107.246.124.3 as “sender address”. This “sender address” in the IP header is first replaced with the “external” IP address 246.154.17.3 by the router R or the NAT entity of the router R.

1.-7. (canceled)

8. A method for setting up a packet-oriented communication link from a first to a second terminal in a data network,
where the data network comprises a local area data network with local addresses in a local address space and a public data network, connected thereto, with global addresses,
where the first terminal is arranged in the local area data network, and
where the first terminal has an associated local address for communication links within the local area data network and an associated global address for communication links to terminals in the public data network,
the method comprising:
sending a test data packet to the second terminal by the first terminal;
detecting a route of the test data packet in the data network;
checking the detected route;
setting up a communication link between the first and second terminals by using the local address of the first terminal as sender address when the check provides that the first and second terminals are arranged in the same local address space; and
setting up a communication link between the first and second terminals by using the global address when the check provides that the first and second terminals are not arranged in the same local address space.

9. The method as claimed in patent claim 8, wherein ascertaining the global address associated with the first terminal via a STUN-server at least when the check provides that the first and second terminals are not arranged in the same local address space.

10. The method as claimed in patent claim 8, wherein the check involves a evaluating a number of hops when transmitting the test data packet to the second terminal.

11. The method as claimed in patent claim 9, further comprising:
sending a test data packet to the STUN server; and
evaluating a number of hops when transmitting the test data packet to the STUN server,
wherein the check involves comparing the number of hops when transmitting the test data packet to the STUN server to the number of hops when transmitting the test data to the second terminal.

12. The method as claimed in patent claim 11, wherein when the comparison establishes that the second terminal and the STUN server are in a data network with the same address space, the communication link is set up by using the global address.

13. The method as claimed in patent claim 8, wherein the public data network used is the internet.

14. A terminal for setting up a packet-oriented communication link in a data network, comprising:
a transmitter for sending packets;
a receiver for receiving packets; and
a device for setting up the communication link to the second terminal,
wherein a test data packet is sent to a second terminal; a route taken by the test packet is detected by the terminal and checked to established whether the second terminal is arranged in the same address space as the first terminal,
wherein a global address associated with the first terminal is detected,
wherein the device uses a local address as the sender address to set up the connection when the first and second terminals are arranged in the same address space, and
wherein the device uses the detected global address as the sender address to set up the connection when the first and second terminals are arranged in separate address spaces.
